(19) United States
(12) Patent Application Publication
(10) Pub. No.: US 2003/0038121 A1
(43) Pub. Date: Feb. 27, 2003

(54) Laser system and method for marking gemstones

(76) Inventor: C. Paul Christensen, Fairhaven, MD (US)

Correspondence Address: ROSENBERG, KLEIN & LEE, 3458 ELLICOTT CENTER DRIVE-SUITE 101, ELLICOTT CITY, MD, 21043, US

(21) Appl. No.: 10/045,166

(22) Filed: Jan. 15, 2002

Related U.S. Application Data
(60) Provisional application No. 60/261,210, filed on Jan. 16, 2001.

(51) Int. Cl. B23K 26/00; B23K 26/14; B23K 26/16; B23K 26/18

(52) U.S. Cl. 219/121.68

(57) ABSTRACT

A system and method for marking a surface of a gemstone employs an optical passage member positioned in the resonant cavity of an excimer laser in proximity to the front laser mirror, so that to pattern the generated laser beam in a predetermined fashion and to expose the gemstone to the patterned laser beam for evaporating the material of the gemstone from the surface of the gemstone at locations predetermined by the optical passage member. The system is operated in two marking modes. At the first mode, when the optical passage member is an aperture, a simple spot is projected onto the surface of the gemstone, and in order to inscribe the marks and characters on the surface of the gemstone, the gemstone is moved with respect to the laser beam by a precision motion system in accordance with a pre-set pattern. Alternatively, a more complex image may be inscribed on the surface of the gemstone without moving the gemstone by means of projecting the image of the projection mask placed inside the laser resonant cavity. A software developed specifically for the system of the present invention runs the whole system and coordinates the operation of different portions thereof.

### CROSS REFERENCE TO RELATED PATENT APPLICATION

The subject Utility Patent Application is based upon a Provisional Application No. 60/261,210 filed Jan. 16, 2001.

### BACKGROUND OF THE INVENTION

1. Field of the Invention

The present invention relates to the systems for marking diamonds and other gemstones; and more particularly, to a laser system employing an intracavity mask or aperture positioned in the resonant cavity of the laser, in which the image of the intracavity mask is projected onto the surface of a gemstone to be marked by vaporization of the gemstone material exposed to the laser beam.

2. Prior Art

Laser marking systems for inscribing various indicia on diamond gemstones have been shown in U.S. Pat. Nos. 4,392,476; 4,467,172; and, 5,932,199. These systems utilize energy from a pulsed laser to ablate or vaporize material from the girdle or one or more facets of the polished gemstone as the gemstone is moved under the focused laser beam. These systems utilize lasers radiating in a visible spectrum area. Since high quality diamond gemstones absorb very little visible light, relatively high laser pulsed energy is to be used to vaporize the surface material, that is associated with the risk of damage to the o gemstone. In another system for gemstones marking, described in U.S. Pat. Nos. 5,410,125 and 5,573,684, the pattern of markings is defined by masks left between an ultraviolet excimer laser and a surface of a diamond gemstone. This pattern projection technique may be used to mark a gemstone without the use of an associated motion system. Ultraviolet wavelengths are more strongly absorbed by diamonds, thus allowing the reduction of the laser energy required for marking a gemstone surface. However, the patterned mask is subject to erosion by the laser beam, and a sophisticated optical system is often required for projection of very small or intricate patterns.

It is well known in the art, that lasers, such as excimer lasers, operating in multiple transverse modes, normally emit laser beams characterized by a limited degree of spatial coherence due to the effect of the laser beam divergence. Introducing a single aperture of an appropriate size into the laser cavity, can reduce the divergence of a laser. Reduction of the beam divergence of the laser allows use of smaller, less expensive optics when focusing the laser into a small focal spot.

M. Lawandy, et al., “Laser Focus World”, 33, May 1997, demonstrated that an image of a patterned optical transmission mask placed inside the cavity of an appropriate multimode laser, may be formed with optics placed outside of the laser. Since the mask suppresses laser operation in those regions transferred to the optical axis of the laser in which the mask is opaque, the laser energy absorbed by the mask is minimal.

The principles of a patterned optical transmission mask placed inside the cavity of a multimode laser have never been applied, however, specifically to marking gemstones.

### SUMMARY OF THE INVENTION

It is therefore an object of the present invention to provide a laser based gemstone marking system using a laser adapted to project images of masks or apertures located inside the resonator cavity of the laser for gemstones surface vaporization at the areas exposed to the laser beam.

It is a further object of the present invention to provide a gemstone marking system employing an excimer laser with highly multimode output, wherein the inherent low spatial coherence of the out beams is improved, and therein the reduction of the beam divergence allows the use of smaller and less expensive optics.

It is still a further object of the present invention to provide a laser based gemstone marking system allowing to increase the operating lifetime of projection masks and apertures by placing the same into the resonant cavity of the laser.

According to the teachings of the present invention, a laser system for marking a surface of gemstones comprises a laser generating a laser beam, an optical passage member (in the form of either an aperture or a projection mask) positioned within the resonant cavity of the laser in proximity to the front laser mirror, a gemstone supporting fixture, and an optical system for imaging the optical passage member on the surface of the gemstone to be marked.

More specifically, the image of the optical passage member onto the surface of the gemstone constitutes a laser beam generated by the laser and patterned by the optical passage member within the resonant cavity thereof. The patterned laser beam impinges upon the surface of the gemstone to be marked and evaporates the material of the gemstone from the surface thereof at the areas exposed to the laser beam.

The laser employed in the system of the present invention may be a pulsed multimode laser source, preferably, excimer laser. The image of the aperture or projection mask is projected onto the gemstone surface using an optical system (preferably lenses), of appropriate focal length, which are placed in position suitable for production of the desired image demagnification. When the optical energy density of the laser beam at the gemstone surface exceeds a certain threshold level, each laser pulse will vaporize a shallow layer of material from the surface in those regions that are optically illuminated (exposed to the laser beam).

The system can be operated in two marking modes. In a first mode, when a single aperture inside the resonant cavity is used as an optical passage member, a simple spot is projected onto the surface of a gemstone. Then, marks and characters may be inscribed on the surface of the gemstone by moving the gemstone under the imaged spot using a precision motion system operatively coupled to a gemstone holding fixture and controlled by processing means, such as, for example, a computer run by a software developed for this purpose.

Alternatively, a more complex image, such as a logo or image of a full character or characters, may be inscribed without moving the gemstone relative to the laser beam, by projecting onto the marking surface the image of the corresponding projection mask placed inside the laser resonant cavity.

The operation of the system may be enhanced if the system includes a means for viewing the surface to be marked, preferably by a video camera, with optical magnification, and means for determining the relative position of the focal plane of the laser beam and the marking surface of the gemstone. Preferably, the system also includes a computer for programmable control of the motion system and the laser output, means for recording images of selected areas of the surface of the gemstone, and means for recording information relevant to the gemstone in an electronic database.

Viewing in another aspect thereof, the present invention is a method for marking the surface of a gemstone, comprising the steps of:

positioning an optical passage member within the resonant cavity of a laser in proximity to the front laser mirror thereof,

actuating the laser for generating a laser beam patterned by the optical passage member, and

exposing the gemstone to the patterned laser beam for evaporating the material of the gemstone from the surface thereof at predetermined locations.

The laser beam is directed to the surface of the gemstone through an optical system, preferably optical lenses, for imaging the optical passage member thereon. The surface of the gemstone is to be positioned in the focal plane of the laser beam, and the intensity of the laser beam is brought to a predetermined threshold where the evaporation takes place.

When the optical passage member within the resonant cavity of the laser includes an aperture, a simple spot is projected onto the surface of the gem, and in order to inscribe the marks and characters on the surface of the gemstone, the gemstone is moved by the precision motion system under the control of a computer relative to the laser beam. If a more complex image such as a logo or a full character is to be inscribed on the surface of the gemstone, the gemstone is maintained immovable and the whole image is created at the surface of the gemstone by exposing the surface of the gemstone to the laser beam patterned by a projection mask placed inside the laser cavity.

During the operation of the system of the present invention, the surface of the gemstone is viewed with optical magnification during the process, and images of selected areas of the gemstone are recorded, preferably by video camera, and the data corresponding to the recorded images are recorded in an electronic database.

These and other novel features and advantages of the subject invention will be more fully understood from the following detailed description of the accompanying drawings.

### BRIEF DESCRIPTION OF THE DRAWINGS

FIG. 1 is a schematic representation of a block diagram of the system for marking a surface of a gemstone of the present invention; and

FIG. 2 is a flow chart diagram of the process of the present invention for marking a surface of a gemstone.

### DETAILED DESCRIPTION OF THE PREFERRED EMBODIMENTS

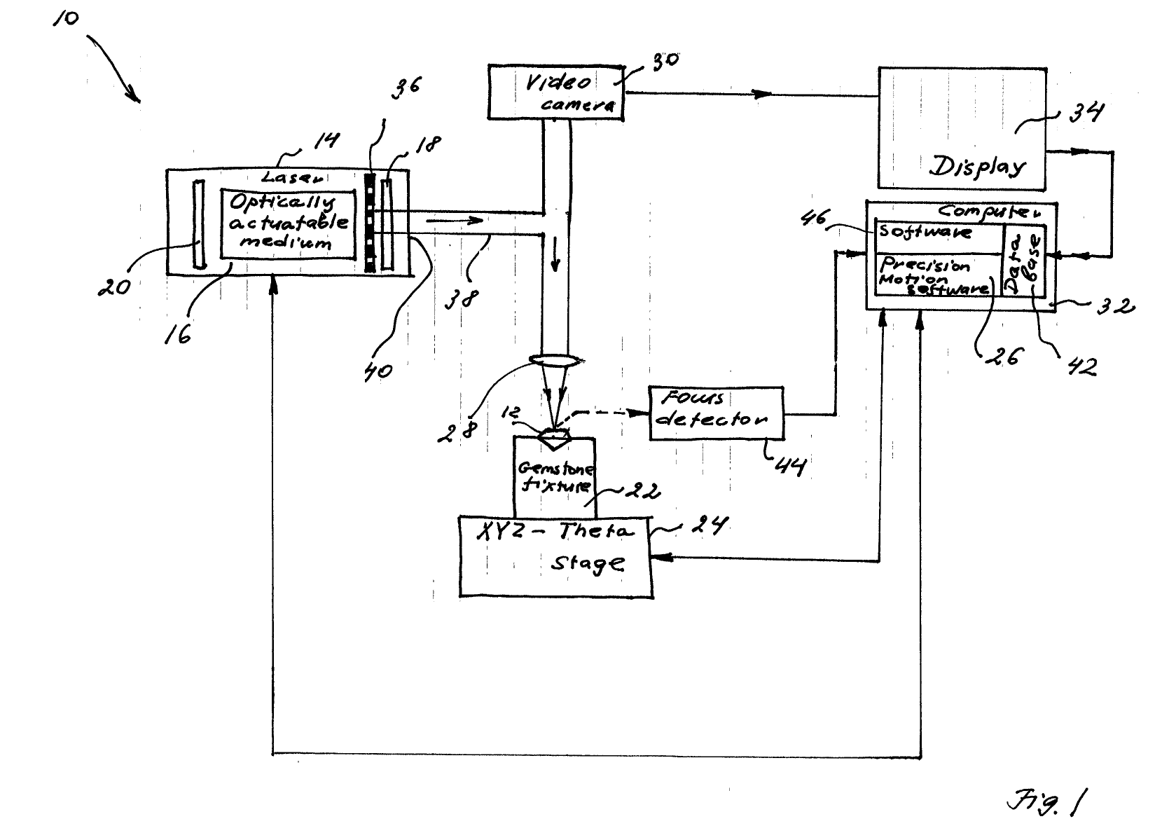

Referring to FIG. 1, a laser system 10 for marking a surface of a gemstone 12 includes a laser 14 having a resonant cavity 16 sandwiched between a front laser mirror 18 and a rear laser mirror 20, a fixture 22 supporting the gemstone 12 thereon, a stage 24 controllable to move in XYZ direction under the supervision of a precision motion software 26, an imaging optics 28, a video camera 30, and a computer 32 with the display 34.

An optical passage member 36 is positioned within the resonant cavity 16 of the laser 14 in proximity to the front laser mirror 18 so that upon actuation of the laser 14, the generated laser beam 38 is patterned in accordance with the shape of the optical passage member 36. For example, if the optical passage member 36 is an aperture, then the laser beam 38 output from the output 40 of the laser 14 represents a simple beam. While, if the optical passage member 36 is a projection mask having an intricate pattern created thereon, the generated laser beam 38 output from the laser 14 is patterned accordingly and carries the information corresponding to the pattern created on the projection mask.

The laser 14 is preferably an excimer laser exhibiting highly multimode output. The function of the optical passage member 36 is to suppress laser operation in those regions transverse to the optical axes of the laser in which the optical passage member, either in the form of an aperture or a projection mask, is opaque. Thus, the laser beam 38 output from the laser 14 if viewed in cross-section thereof, represents either peaks of intensity at the areas corresponding to the transparent portions of the optical passage member 36, and portions of a low intensity at the areas corresponding to the opaque portions of the optical passage member 36.

In order to create a mark on the surface of the gemstone 12, the surface of the gemstone is to be exposed to the patterned laser beam 38. Creating the image of the optical passage member 36 placed inside the laser resonant cavity 16 onto the surface of the gemstone 12 is achieved by means of the imaging optic system 28 which preferably uses lenses of appropriate focal length placed at positions suitable for production of the desired image magnification. Once the surface of the gemstone 12 is exposed to the patterned laser beam 38, and when the optical energy density of the laser beam at the gemstone surface exceeds a predetermined threshold level, each laser pulse will vaporize a shallow layer of material from the surface of the gemstone at those regions that are optically illuminating.

The system 10 can be operated in either of two marking modes. In the first mode, when the optical passage member 36 represents an aperture, a simple spot is projected onto the surface of the gemstone 12, and marks and characters may be then inscribed on the surface of the gemstone by moving the gemstone under the image spot using the precision motion system 26 which sets the gemstone fixture 22 displacement pattern and which will displace the stage 24 carrying the fixture 22 thereon in XY directions.

In another operational mode, a more complex image such as a logo, or image of a full character or characters may be inscribed without moving the gemstone 12 by projection of the image of the corresponding projection mask placed within the laser resonant cavity 16 onto the surface of the gemstone 12 and by maintaining the exposure of the gemstone to the laser beam 38 for a predetermined time, sufficient to inscribe the mark of a predetermined depth on the surface of the gemstone 12.

The operation of the system 10 of the present invention is enhanced by using the video camera 30 for viewing the surface of the gemstone 12 to be marked with optical magnification and with recording the images of preselected surface areas of the gemstone in an electronic database 42 in the computer 32. The computer also provides the system 10 with the capability of displaying the magnified or non-magnified images of the surface of the gemstone 12 on the display 34.

The system 10 of the present invention also allows determining the relative positions of the focal plane of the generated laser beam 38 and the marking surface of the gemstone 12. For this purpose, a focus detector 44 and the software 46 of the present invention within the computer 32, monitors the position of the stage 24 carrying the gemstone 12, and, if the deviation of the marking surface of the gemstone 12 from the focal plane of the laser beam 38 is detected, the software 46 of the present invention will relocate the stage 24 in the vertical direction to bring the surface of the gemstone 12 to the focal plane of the laser beam 38 for the high quality of the marks inscribed on the surface of the gemstone.

The computer 32 is operationally coupled to the motion system of the stage 24 and to the laser 14 for programmable control of the position of the gemstone 12 and the laser output in order to coordinate the operation of the whole system of the present invention and to insure the high quality of marks inscribed on the surface of the gemstone 12. The computer 32 controls the laser energy, pulse emission time and duration, as well as stage motion, either in order to place the surface of the gemstone into the focal plane of the laser beam 38 or to follow the gemstone fixture displacement pattern (when the optical passage member is an aperture), and/or the duration of exposure of the surface of the gemstone to the patterned laser beam (when the optical passage member is a projection mask).

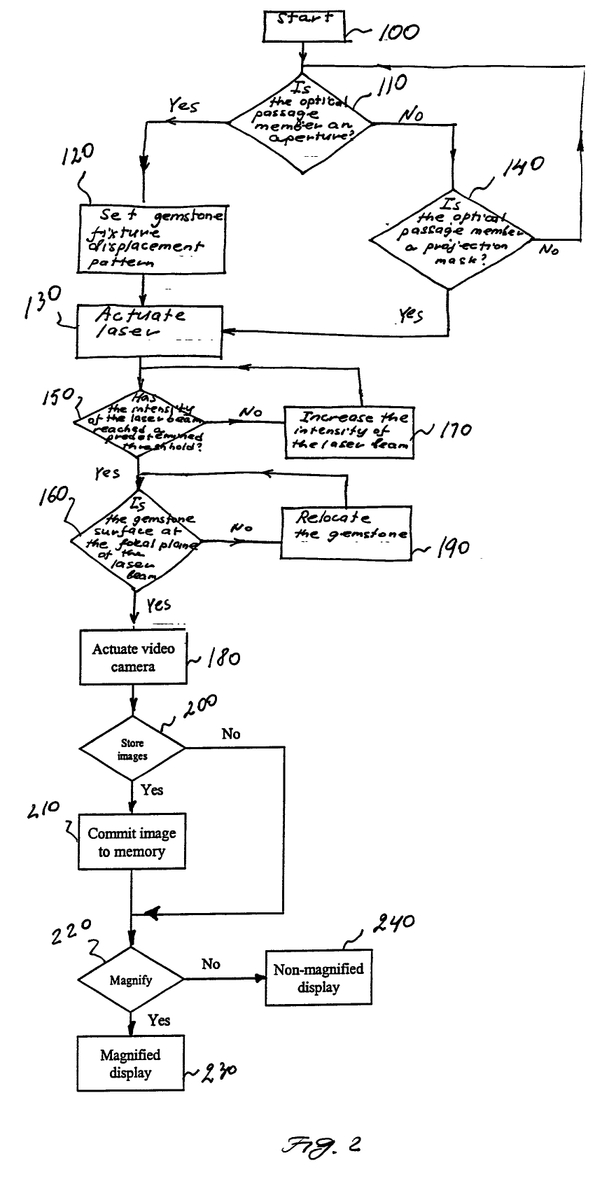

Referring to FIG. 2, which represents a flow chart diagram of the software running the gemstone marking system 10 of the present invention, the process starts as the block 100 when the gemstone 12 is positioned in the gemstone fixture 22 and the optical passage member 36 is positioned within the resonant cavity 16 of the laser 14.

The logic moves to block 110 “Is the optical passage member an aperture?”. If the optical passage member within the laser 14 is an aperture, the flow chart moves to the block 120 “Set gemstone fixture displacement pattern”, wherein the precision motion software 26 defines a fashion of relocation of the stage 24 with respect to the laser beam 38 (specifically, a simple spot projected onto the surface of the gemstone 12), so that the marks and characters may be inscribed by moving the gemstone under the imaged spot. From the block 120, the logic flows to the block 130 “Actuate Laser”.

If, however, in the block 110, the optical passage member is not an aperture, the logic passes to block 140 “Is the optical passage member a projection mask?”. If the optical passage member is a projection mask, the flow chart moves from the block 140 to the block 130 “Actuate Laser”. If, however, the optical passage member is not a projection mask in block 140, the logic returns to block 110.

Upon actuating the laser 14 in block 130, the flow chart moves to block 150 “Has the intensity of the laser beam reached a predetermined threshold?”, where the system judges whether the intensity of the laser beam is sufficient to evaporate the material of the gemstone. If, however, the intensity of the laser beam in the block 150 has not reached a predetermined threshold, the logic moves to the block 170 “Increase the intensity of the laser beam” and from there returns to block 150. If the intensity of the laser beam has reached a predetermined threshold, the logic moves to the block 160 “Is the gemstone surface at the focal plane of the laser beam?”.

In the block 160, if the gemstone surface is at the focal plane of the laser beam, the logic moves to block 180 “Actuate video camera” so that the video camera 30 is actuated for viewing the surface to be marked of the gemstone with optical magnification thereof and for supplying data related to such an action to the computer 32 for being displayed on the display 34. If, however, in block 160, the system of the present invention detected displacement of the gemstone surface from the focal plane of the laser beam, the logic flows to the block 190 “Relocate the gemstone” and returns to block 160.

Upon actuating the video camera in block 180, the logic flows to the block 200 “Store images?”. If the images viewed by the video camera 30 are to be stored, the logic flows to block 210 “Commit image to memory” so that the image can be recorded in the electronic database of the computer 32. If the images are not to be stored, the logic flows from the block 200 to the block 220 “Magnify?”, bypassing the block 210, i.e. without recording the images into the electronic database 42.

If the images are to be magnified, the flow chart moves to the block 230 “Magnified display”, so that the magnified image can be displayed on the display 34. If, however, the image is not to be magnified, the flow chart moves from block 220 to block 240 “Non-magnified display” to display non-magnified image on the display 34.

Although this invention has been described in connection with specific forms and embodiments thereof, it will be appreciated that various modifications other than those discussed above may be resorted to without departing from the spirit or scope of the invention. For example, equivalent elements may be substituted for those specifically shown and described, certain features may be used independently of other features, and in certain cases, particular locations of elements may be reversed or interposed, all without departing from the spirit or scope of the invention as defined in the appended claims.

What is claimed is:

1. A laser system for marking a surface of gemstones, comprising:
a laser having a resonant cavity and a front and a rear laser mirror sandwiching said resonant cavity therebetween, said laser generating a laser beam;
an optical passage member positioned within said resonant cavity in proximity to said front laser mirror, said optical passage member patterning said laser beam in a predetermined fashion; and
means for exposing said gemstone to said patterned laser beam for evaporating the material of the gemstone from the surface thereof at locations predetermined by said optical passage member.

2. The laser system of claim 1, further comprising:
means for positioning the surface of the gemstone to be marked at the focal plane of said patterned laser beam.

3. The laser system of claim 1, further comprising:
an optical system coupled between an output of said laser and said gemstone for imaging said optical passage member on the surface of the gemstone.

4. The laser system of claim 1, further comprising:
motion means operatively coupled to the gemstone for moving the gemstone relative to said laser beam in a predetermined manner.

5. The laser system of claim 4, wherein said optical passage member includes an aperture.

6. The laser system of claim 1, wherein said optical passage member includes a projection mask.

7. The laser system of claim 1, further comprising:
an optical magnification means for viewing the surface of the gemstone to be marked.

8. The laser system of claim 1, further comprising:
means for controlling output of said laser.

9. The laser system of claim 1, further comprising:
means for recording images of the surface of the gemstone.

10. The laser system of claim 1, further comprising:
means for recording data relative to the gemstone in an electronic database.

11. A laser system for marking a surface of gemstones, comprising:
a laser generating a laser beam, said laser having a resonant cavity and front and rear laser mirrors sandwiching said resonant cavity therebetween;
an optical passage member positioned within said resonant cavity in proximity to said front laser mirror and in transverse juxtaposition with said laser beam;
a gemstone supporting means; and
an optical system for imaging said optical passage member on the surface of the gemstone to be marked, thereby exposing at least one predetermined area of the surface of the gemstone to said laser beam for evaporating a material of the gemstone therefrom.

12. The laser system of claim 11, wherein said optical passage member includes an aperture.

13. The laser system of claim 11, wherein said optical passage member includes a projection mask having a predetermined pattern created thereon.

14. The laser system of claim 12, further comprising a precision motion means operatively coupled to said gemstone supporting means for moving the gemstone according to a predetermined pattern relative to the image of said aperture on the surface of the gemstone.

15. The laser system of claim 11, further comprising an optical magnification means optically coupled to said gemstone for viewing the surface of the gemstone to be marked.

16. The laser system of claim 15, further comprising positioning means operatively coupled to said gemstone and to said gemstone supporting means for determining a relative position between a focal plane of said laser beam and the surface of the gemstone to be marked, and for relocating the gemstone once the fluctuation of the marking surface of the gemstone from said focal plane has been detected.

17. The laser system of claim 11, further comprising processing means operatively coupled to said gemstone supporting means for controlling the position thereof.

18. The laser system of claim 17, further comprising processing means operatively coupled to said laser for controlling the operation of said laser.

19. The laser system of claim 11, further comprising means for recoding images of predetermined areas of the surface of the gemstone in an electronic database.

20. The laser system of claim 11, wherein said laser includes an excimer laser.

21. A method for marking a surface of a gemstone, comprising the steps of:
providing a laser having a resonant cavity and a front and a rear laser mirror sandwiching said resonant cavity therebetween;
positioning an optical passage member within said resonant cavity of said laser in proximity to said front laser mirror;
actuating said laser, thus generating a laser beam patterned by said optical passage member; and
exposing the gemstone to said patterned laser beam for evaporating the material of the gemstone from the surface thereof at predetermined locations.

22. the method of claim 21, further comprising the steps of:
directing said laser beam to said predetermined location at the surface of the gemstone through an optical system, thereby imaging said optical passage member thereon.

23. The method of claim 21, further comprising the steps of:
moving the gemstone relative to said laser beam.

24. The method of claim 21, further comprising the steps of:
positioning the surface of the gemstone in the focal plane of said laser beam, and bringing intensity of said laser beam to a predetermined threshold.

25. A method for marking surface of a gemstone, comprising the steps of:
providing a laser having a resonant cavity and front and rear laser mirrors sandwiching said resonant cavity therebetween;
positioning an optical passage member within said resonant cavity of said laser in proximity to said front laser mirror;
positioning a gemstone at a predetermined position relative to said laser;
positioning an optical system between said laser and the gemstone;
actuating said laser to generate a laser to generate a laser beam patterned by said optical passage member; and
directing said laser beam to the surface of the gemstone through said optical system to image said optical passage member on the surface of the gemstone to be marked, thereby exposing the gemstone to said laser beam at at least one predetermined area of the surface thereof for evaporating material of the gemstone therefrom.

26. the method of claim 25, further comprising the steps of:
moving said gemstone relative to said laser beam in accordance with a predetermined pattern.

27. The method of claim 25, further comprising the steps of:
magnifying and viewing the surface of the gemstone.

28. The method of claim 25, further comprising the steps of:
determining a relative position between a focal plane of said laser beam and the surface of the gemstone.

29. The method of claim 25, further comprising the steps of:
operatively coupling positioning means to the gemstone for controlling the position thereof.

30. The method of claim 25, further comprising the steps of:
controlling the operation of said laser.

31. The method of claim 25, further comprising the steps of:
recording images of preselected areas of the surface of the gemstone into an electronic database.
